(19) United States
(12) Patent Application Publication
(10) Pub. No.: US 2020/0142094 A1
(43) Pub. Date: May 7, 2020

(54) MEASURING ATMOSPHERIC CONDITIONS USING MACHINE LEARNING

(71) Applicant: LOON LLC, Mountain View, CA (US)

(72) Inventors: Daniel George, Mountain View, CA (US); Cyrus Behroozi, Menlo Park, CA (US)

(21) Appl. No.: 16/181,278

(22) Filed: Nov. 5, 2018

(51) Int. Cl. G01W 1/08; G01W 1/06; G01C 5/00; G01P 5/24; G06N 99/00

(52) U.S. Cl. CPC G01W 1/08; G01W 1/06; G06N 99/005; G01P 5/245; G01C 5/00

(57) ABSTRACT

Methods, systems, and apparatus, including computer programs encoded on a computer storage medium, for determining atmospheric conditions. In one aspect, a method includes receiving data relating to atmospheric conditions collected at a particular altitude located within the stratosphere, providing the data to a machine-learned model that has been trained using a training data set collected in a controlled environment, determining, by the machine-learned model, atmospheric conditions data for the particular altitude based on the data collected for the particular altitude and storing the atmospheric conditions data for the particular altitude.

### BACKGROUND

This specification relates to determining atmospheric conditions.

### SUMMARY

This specification describes technologies relating to determining atmospheric conditions (e.g., temperature and pressure) at various altitudes in the atmosphere (e.g., upper troposphere or stratosphere). The technology utilizes a machine-learned model to determine atmospheric conditions, (e.g., air temperature and atmospheric pressure) for a particular altitude using data collected by a sonic anemometer at the particular altitude.

In general, one innovative aspect can be embodied in methods for determining atmospheric conditions that include the actions of receiving data relating to atmospheric conditions (e.g., ambient temperature and pressure) collected at a particular altitude where the particular altitude is located within the stratosphere or the upper troposphere. The data is provided to a machine-learned model that has been trained using a training data set collected in a controlled environment, for example, using a thermal vacuum chamber. The machine-learned model can determine atmospheric conditions data (e.g., temperature and pressure) for the particular altitude based on the data collected for the particular altitude. The atmospheric conditions data is stored for the particular altitude. Other embodiments of this aspect include corresponding systems, apparatus, and computer programs, configured to perform the actions of the methods, encoded on computer storage devices.

These and other embodiments can each optionally include one or more of the following features. In some implementations, the atmospheric conditions include an ambient temperature at the particular altitude and the atmospheric conditions data is temperature data for the particular altitude.

In some implementations, the atmospheric conditions include an absolute pressure at the particular altitude and the atmospheric conditions data is pressure data for the particular altitude, where the pressure data and temperature data for the particular altitude are interdependent such that the data collected at the particular altitude depends on both temperature and pressure at the particular altitude.

In some implementations, the data includes a set of time-of-flight measurements, where each time-of-flight measurement includes a sonic pulse between a transmitting transducer and a receiving transducer, and where each pulse is defined in part by a pulse waveform and a characteristic shape of the pulse waveform. The shape of the pulse waveform can include, for example, an amplitude of the pulse waveform.

In some implementations, determining temperature data and pressure data for the particular altitude based on the data collected for the particular altitude is based in part on the characteristic shape of the waveform for each pulse in the set of pulses in the collected data. For example, the amplitude of the received pulse waveform is reduced with respect to a transmitted pulse waveform as absolute pressure decreases for a constant atmospheric temperature.

In some implementations, the data is collected using a sonic anemometer located at the particular altitude, and where the set of pulses are ultrasonic pulses between pairs of transducers of the sonic anemometer.

In some implementations, the temperature data for the particular altitude is an atmospheric temperature and the pressure data is an absolute pressure at the particular altitude.

In general, another aspect can be embodied in a system for determining atmospheric conditions including an altitude detection device, a positioning mechanism, a wind sensor package that is positioned at an altitude using the positioning mechanism that is measurable by the altitude detection device, and one or more computers in data communication with the wind sensor package, positioning mechanism, and altitude detection device and operable to perform the operations including: receiving data relating to atmospheric conditions (e.g., ambient temperature and pressure) collected by the wind sensor package at a particular altitude that is located within the stratosphere or upper troposphere and determined in part by a position determined by the positioning mechanism of the wind sensor package and altitude data collected by the altitude detection device (e.g., an altimeter). The data is provided to a machine-learned model that has been trained using a training data set collected in a controlled environment (e.g., using a thermal vacuum chamber). Atmospheric conditions data (e.g., temperature data and/or pressure data) is determined using the machine-learned model for the particular altitude based on the data collected for the particular altitude and stored.

In some implementations, the wind sensor package includes a sonic anemometer.

In some implementations, the positioning mechanism is connected to the wind sensor package by a tether where the positioning mechanism and tether can position the wind sensor package at a particular altitude located in the upper troposphere or stratosphere.

In some implementations, the apparatus includes a balloon, for example, a weather balloon or long-duration scientific balloon, where the one or more computers, the positioning mechanism, and the altitude detection device are a main payload for the balloon and the wind sensor package is attached to the positioning mechanism in the main payload by a tether. The wind sensor package can be in data communication via a wireless data link to the main payload where the main payload is in data communication with one or more users via a satellite communication link.

Among other advantages, the disclosed technology can be used to determine atmospheric temperature and pressure with equal or better precision than certain conventional technology. For example, the indirect temperature measurements using the disclosed technology can be more accurate than state-of-the-art temperature measurement techniques (e.g., thermocouples, atmospheric thermometers) because the disclosed technology uses the surrounding air as the thermometer rather than measuring a temperature of the device itself. As a result, the temperature measurements are generally resistant to the effects of solar-related biases, wind-related biases, and/or measurement device temperature. In another example, pressure measurements using the disclosed technology can be equally if not more accurate than state-of-the-art pressure measurement techniques (e.g., MEMS-based pressure sensors) and do not have the same temperature-sensitivity as MEMS-based pressure sensors that can add error to the pressure measurements.

Moreover, the machine-learning model can be trained to receive raw data collected by the sonic anemometer with minimal pre-processing, e.g., normalization only, keeping processing requirements modest. Cost, weight, and complexity of the atmospheric conditions measurement system can be reduced and reliability of the system can be increased by using a single instrument (e.g., the sonic anemometer) instead of multiple different instruments to measure temperature, pressure, wind, and the like.

The details of one or more embodiments described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example atmospheric conditions measurement system.

FIG. 1B shows another example atmospheric conditions measurement system.

FIG. 2 shows an example sonic anemometer device.

FIGS. 3A and 3B show example waveform pulses and respective waveform envelopes for the waveform pulses collected at two different atmospheric conditions.

FIG. 4 shows an example set of waveform pulses and waveform envelopes for the waveform pulses collected at a same atmospheric condition.

FIG. 5 is a flow diagram of an example process for training a machine learned model for the atmospheric conditions measurement system.

FIG. 6 is a flow diagram of an example process for measuring atmospheric conditions using the atmospheric conditions measurement system.

### DETAILED DESCRIPTION

Overview

The technology of this patent application determines temperature and pressure at various altitudes in the stratosphere. The technology utilizes a machine-learned model to determine atmospheric conditions (e.g., temperature and pressure) for a particular altitude, where the atmospheric conditions are inferred from data collected by a sonic anemometer (e.g., time-of-flight measurements) at the particular altitude.

More particularly, the technology uses ultrasonic pulses collected by a sonic anemometer at various altitudes to infer a corresponding atmospheric temperature and pressure using a machine-learned model. The machine-learned model is trained using supervised learning on a training set collected in a controlled environment, e.g., a thermal vacuum chamber, through a range of temperatures and pressures. The collected data is in the form of ultrasonic pulses between a pair of transducers of the sonic anemometer, where, for each measurement, one transducer operates as a transmitter and one transducer operates as a receiver. A time-of-flight of the pulses is measured as well as a characteristic shape of the pulse waveform, e.g., amplitude vs. time. The machine-learned model can infer an atmospheric temperature and absolute pressure at a particular altitude using raw waveform pulse data collected at the particular altitude by the sonic anemometer including the shape, e.g., amplitude, of an envelope of the pulse and the time-of-flight of the pulse. In some embodiments, the sonic anemometer collects a set of data at each altitude including 8 vectors between 4 transmitter/receiver pairs to account for wind effects.

Example Atmospheric Conditions Measurement System

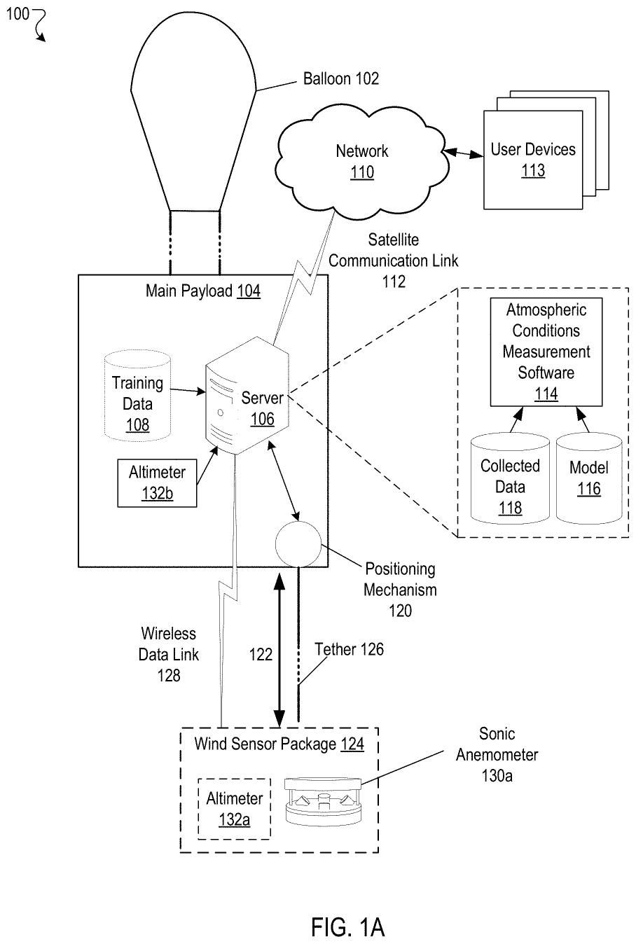

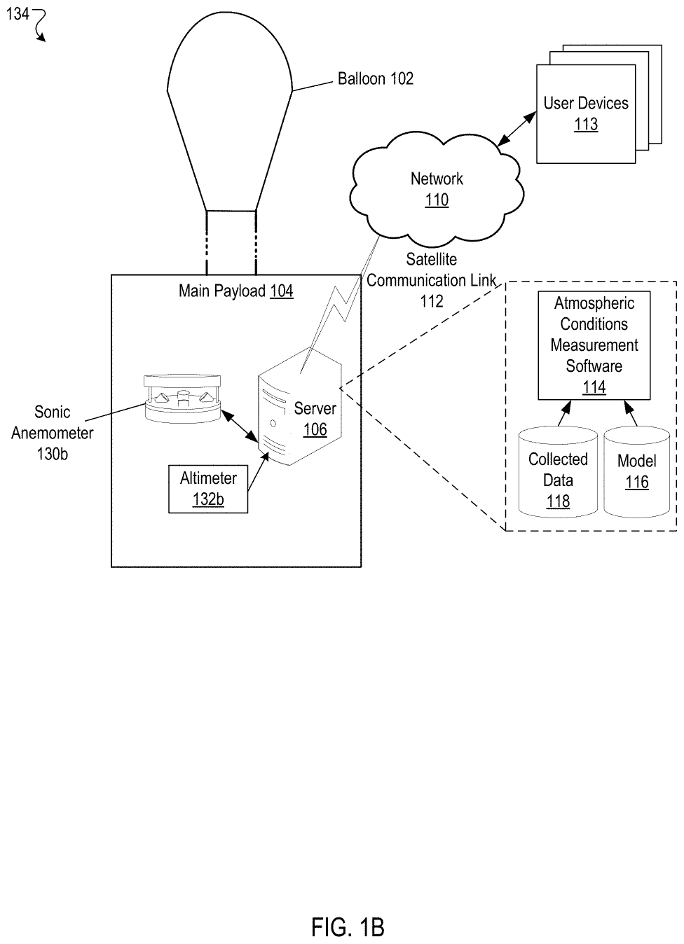

FIG. 1A shows an example atmospheric conditions measurement system 100. The system 100 includes a balloon 102 to control a position of the system 100 within the atmosphere, for example, in the stratosphere or in the upper troposphere. Balloon 102 can be, for example, a weather balloon, a long-duration scientific balloon, or the like. The balloon 102 is affixed to a main payload 104, for example, using a non-rigid (e.g., string or rope) or rigid (e.g., a truss structure) attachment.

The main payload 104 can include a server 106 including one or more hardware processors and memory. For example, an atmospheric conditions measurement program 114 can be stored in the memory and run on the one or more processors to implement the techniques described herein. In some implementations, server 106 can include one or more databases for storing data, for example, training data 108.

Server 106 can be in data communication with a network 110, for example, through a satellite communication link 112. The network 110 such as a local area network (LAN), wide area network (WAN), the Internet, or a combination thereof, can connect the system 100 to a user device 113. In some implementations, the system 100 is deployed in the upper troposphere or stratosphere and a user with user device 113 is located at a ground-based facility receiving the atmospheric conditions measurements from the system 100.

A user device 113 is an electronic device capable of requesting and receiving resources over the network 110. Example user devices 113 include personal computers, mobile communication devices, and other devices that can send and receive data over the network 110. A user device 113 typically includes a user application, such as a web browser, to facilitate the sending and receiving of data over the network 110. In some implementations, a user on a user device 113 can view data collected by the system 100 in real-time or receive periodic updates of data collected by the system 100.

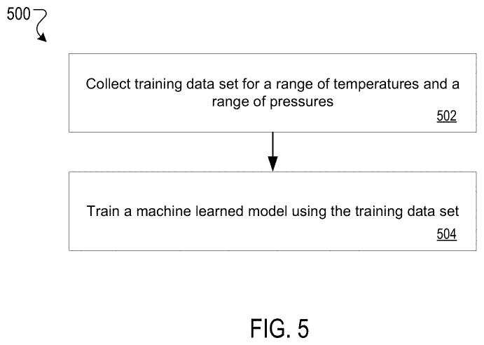

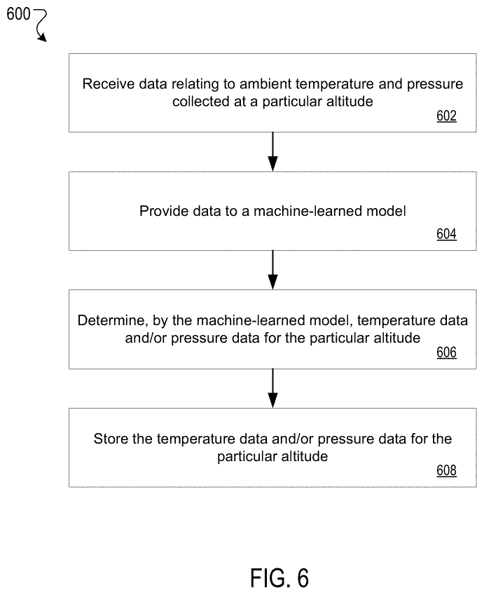

Atmospheric conditions measurement program 114 on the server 106 can control one or more aspects of the data collection, data processing using one or more machine-learned models 116, data storage of atmospheric conditions measurements 118, and transmission of the collected data over the network 110 to user devices 113. Operation of the atmospheric conditions measurement program 114 is described in more detail below with reference to FIGS. 5 and 6.

In some implementations, atmospheric conditions measurement program 114 is in data communication with a positioning mechanism 120 and can provide instructions to a positioning mechanism 120 to control a distance 122 between the positioning mechanism 120 and a wind sensor package 124, where the wind sensor package 124 and the positioning mechanism 120 are connected using a tether 126. In some implementations, the positioning mechanism 120 is a winch affixed to the main payload 104 (e.g., fastened using hardware fasteners to a portion of the main payload 104). The winch can include a pulley mechanism for releasing and retracting a length of the tether 126 which in turn increases and decreases the distance 122 between the positioning mechanism 120 on the main payload 104 and the wind sensor package 124. In some implementations, the tether 126 can adjust a distance 122 between the positioning mechanism 120 and the wind sensor package 124, for example, by a range of 4000 meters.

In some implementations, wind sensor package 124 is in data communication with server 106 through a wireless data link 128. Data communication between the wind sensor package 124 and the server 106 can include data collected by the wind sensor package (e.g., atmospheric condition measurements), operating instructions from the server 106 to the wind sensor packages 124 (e.g., what measurements to collect), and the like. Wireless data link 128 can be, for example, a satellite link, a Wi-Fi wireless Ethernet connection, a Bluetooth connection, Z-wave, or the like.

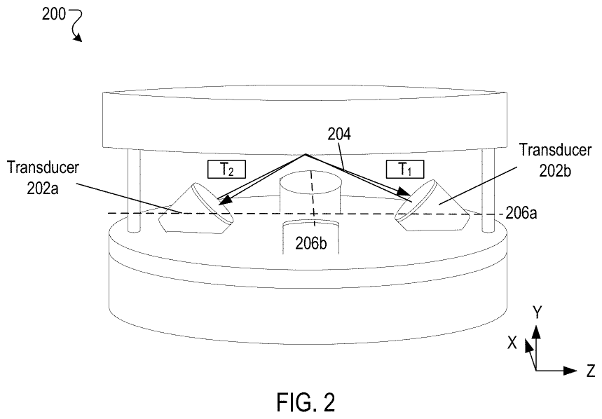

In some implementations, wind sensor package 124 can include a sonic anemometer device 130a, for example, an ultrasonic anemometer. The sonic anemometer device 130a uses ultrasonic sound waves to measure wind velocity by measuring wind speed based on the time-of-flight of sonic pulses between pairs of transducers. Further details of the operation of the sonic anemometer device 130a are found below with reference to FIG. 2. The wind sensor package 124 can additionally include an altimeter 132a or other device for measuring altitude. Alternatively or additionally, the main payload 104 can include an altimeter 132b or another altitude measuring device.

In some implementations, the main payload includes an altimeter 132b and a relative altitude of the wind sensor package can be determined based on a measurement of the altimeter 132b and a distance 122 (e.g., as determined by the length of the extended tether 124) between the wind sensor package 124 and the positioning mechanism 120 that is affixed to the main payload 104. For example, if the altimeter on the main payload 104 reads 20 km and the tether 124 is extended a length of 0.5 km which establishes a distance of 0.5 km between the wind sensor package 124 and the main payload 104, then an altitude of the wind sensor package 124 is 19.5 km.

FIG. 1B shows another example atmospheric conditions measurement system. In another embodiment of the atmospheric conditions measurement system 134, the system includes a balloon 102 that is affixed to a main payload 104, where the main payload 104 includes a sonic anemometer 130b, altimeter 132b, and server 106, where an altitude of the sonic anemometer 130b corresponds to an altitude of the main payload 104 that is determined by a position of the balloon 102, rather than by a length of a tether 126 as in the embodiment described above with reference to FIG. 1A.

FIG. 2 shows an example sonic anemometer device 200, similar to the sonic anemometer 130a and 130b depicted in the wind sensor package 124 of FIG. 1A. Though depicted in FIGS. 1A, 1B, and 2 as a particular design of ultrasonic anemometer device 200, other designs for ultrasonic anemometers are possible for use in the atmospheric conditions measurement system 100. The sonic anemometer 130a and 130b includes one or more pairs of transducers 202a and 202b, for example, a sonic anemometer 130a and 130b can have 2 sets of transducers (e.g., 4 total transducers), 3 sets of transducers (e.g., 6 total transducers), or 4 sets of transducers (e.g., 8 total transducers).

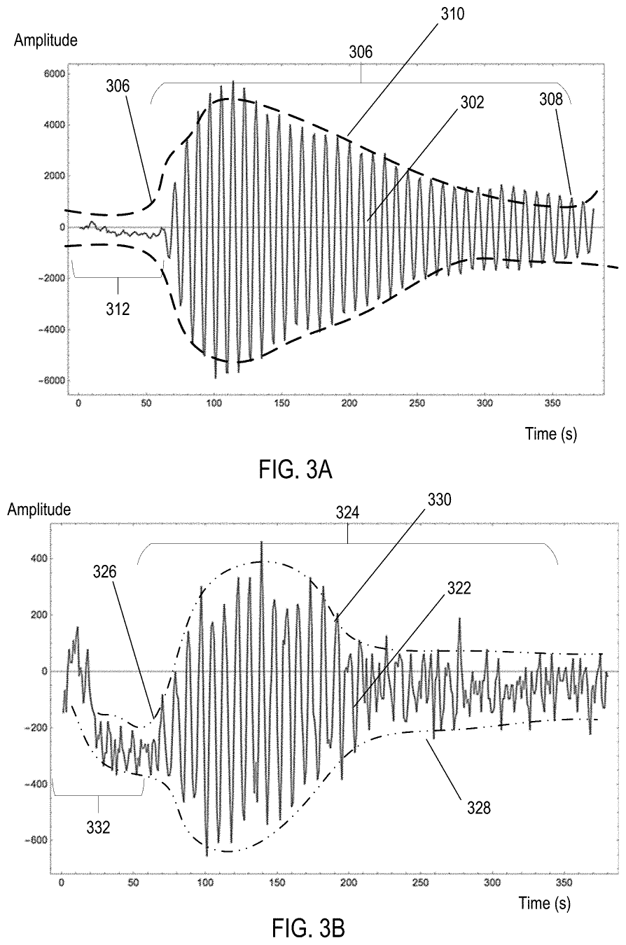

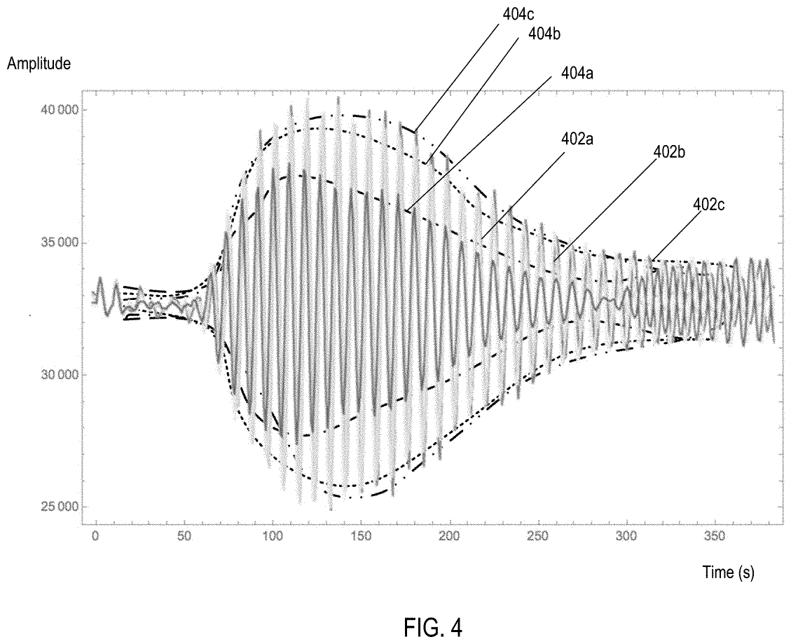

Time-of-flight measurements T₁ and T₂ are collected between pairs of opposing transducers, for example, transducers 202a and 202b, that are located on opposing sides of the sonic anemometer 200 from each other. T₁ is a time-of-flight measurement of an ultrasonic pulse originating from transducer 202a and measured at receiving transducer 202b, and T₂ is a time-of-flight measurement of an ultrasonic pulse originating from transducer 202b and measured at receiving transducer 202a. The pair of transducers are separated by a known path distance L, for example, path distance 204 along an axis, e.g., axis 206a. A waveform pulse is recorded at the receiving transducer for each measurement, where the recorded waveform pulse has a characteristic shape (e.g., amplitude versus time) including an envelope shape. Each time-of-flight measurement can yield information about the atmospheric conditions, for example, air temperature, atmospheric pressure, wind speed and direction, and the like. Multiple time-of-flight measurements are made between pairs of opposing transducers. Further discussion of the waveform pulse and characteristic shape is described below with reference to FIGS. 3A-B and FIG. 4.

Data Collection

FIGS. 3A and 3B show example waveform pulses and respective waveform envelopes for the waveform pulses collected at two different atmospheric conditions. FIG. 3A depicts an example waveform pulse 302 plotted as pulse amplitude versus time. Waveform pulse 302 is collected using a sonic anemometer, e.g., sonic anemometer 200, between two transducers, e.g., transducers 202a and 202b, at a particular altitude (e.g., 100 m above sea level) and under particular atmospheric conditions (e.g., 15° C., 100 kPa). Atmospheric conditions include, for example, a particular air temperature of the air surrounding the sonic anemometer 200 (e.g., between a range 0 to −80° C.) and a particular atmospheric pressure of the air surrounding the sonic anemometer 200 (e.g., between a range of 20 to 2 kPa) through which the waveform pulse 302 is propagating.

Waveform pulse 302 has a set of characteristics associated with the waveform pulse 302 including duration of the pulse 304, a starting point of the pulse 306, an ending point of the pulse 308, an envelope shape 310 of the waveform pulse. Additionally, a time delay 312 between an initiation of the pulse at the transmitting transducer 202a and receiving the pulse at the receiving transducer 202b can be recorded.

In some implementations, a waveform pulse 302 can include 20 periods of sinusoid within a corresponding envelope shape 310.

FIG. 3B depicts another example waveform pulse 320 plotted as pulse amplitude versus time. Waveform pulse 320 is collected using the sonic anemometer 200 at a particular altitude (e.g., 20 km above sea level) and under particular atmospheric conditions (e.g., −57° C., 5 kPa). Waveform pulse 322 has a set of characteristics associated with the waveform pulse 322 including a duration of the pulse 324, a starting point of the pulse 326, an ending point of the pulse 328, an envelope shape 330 of the waveform pulse, and a time delay 332 between initiation of the pulse at the transmitting transducer 202a and receiving the pulse at receiving transducer 202b.

The amplitude of the waveform pulse over the measurement time can yield information about the atmospheric pressure surrounding the sonic anemometer 200. For example, waveform pulse amplitude can decrease for a waveform pulse 302 as atmospheric pressure (e.g., absolute pressure) decreases for a constant atmospheric temperature, as lower pressure air (e.g., decreased density of air molecules) couples a decreased amount of energy of the ultrasonic pulse from the transmitting transducer to the receiving transducer.

Multiple time-of-flight measurements can be collected for a particular altitude, e.g., at 20 km above sea level. For example, multiple ultrasonic pulses can be transmitted at transducer 202a and received at transducer 202b where each pulse is collected as a waveform pulse 302.

In some implementations, time-of-flight measurements can be collected for a particular altitude between multiple different pairs of transducers that are oriented along multiple axes (e.g., axis 206a and axis 206b) of the sonic anemometer 200. Collecting data for multiple different pairs of transducers can be used to isolate the effects of extraneous variables, for example, wind blowing in a particular direction, solar glare locally heating the apparatus, or the like. FIG. 4 depicts an example set of waveform pulses and waveform envelopes for the waveform pulses collected at a same atmospheric condition between multiple pairs of transducers.

Waveform pulses 402a, 402b, and 402c and respective corresponding waveform envelopes 404a, 404b, and 404c are examples of waveforms that can be collected at a particular altitude between three different pairs of transmitting/receiving transducers. In some implementations, a first waveform pulse can be collected between a first transducer and a second transducer, where the first transducer transmits the ultrasonic pulse and the second transducer receives the ultrasonic pulse, and a second waveform pulse can be collected where the second transducer transmits the ultrasonic pulse and the first transducer receives the ultrasonic pulse. In some implementations, 8 vectors are collected from 4 different transducers pairs, where each pair of transducers measures a diagonal axis along 4 different directions of the sonic anemometer 200.

Model Training

FIG. 5 is a flow diagram of an example process 500 for training a machine learned model for the atmospheric conditions measurement system 100. A machine learned model (e.g., machine learned model 116 of FIG. 1) can be generated using, for example, k-nearest neighbors algorithm, linear regression, gradient descent neural networks, and the like. The system 100 may generate and train one or more models, e.g., a temperature model and a pressure model, to use in determining atmospheric conditions based on measurements made using a sonic anemometer. In some implementations, a machine-learned model 116 includes information for both atmospheric pressure and air temperature, where the pressure and temperature for the particular altitude are interdependent such that the data collected at the particular altitude depends on both temperature and pressure at the particular altitude.

A training data set is collected for a range of temperatures and a range of pressures (502). Training data can be collected in a controlled environment where the temperature and pressure of the controlled environment can be precisely regulated and measured. In one example, a thermal vacuum chamber can be a controlled environment, where a range of known pressures and range of known temperatures can be produced within the vacuum chamber and a sonic anemometer located within the controlled environment can collect data (e.g., ultrasonic pulse waveforms) at each particular pressure and temperature setting.

In some implementations, the temperature and pressure ranges produced in the controlled environment are selected based on the temperature and pressure ranges that the wind sensor package 124 will experience when deployed in the field (e.g., in the upper troposphere and stratosphere). A range of temperatures (e.g., 0 to −80° C.) and a range of pressures (e.g., 20 to 2 kPa) can be used. Pressure of the controlled environment can be measured using, for example, using a pressure gauge. Temperature of the controlled environment can be measured using, for example, a thermocouple located within the controlled environment (e.g., adjacent to the sonic anemometer). In one example, a thermocouple can be a capacitive manometer and a resistance temperature detector (RTD).

The training data set can include, for a particular temperature and a particular pressure, a set of waveform pulses collected from the sonic anemometer by transmitting an ultrasonic pulse at a first transducer 202a and receiving the ultrasonic pulse at a second transducer 202b.

A machine-learned model is trained using the training data set (504). The training data set including a set of waveform pulses collected for the range of temperatures and pressures is provided to a machine-learned model. The machine-learned model is trained using supervised learning such that it can infer temperature and pressure at a particular altitude from the raw collected data (e.g., waveform pulses).

The trained machine-learned model can be deployed with the system 100. In some implementations, the machine-learned model can be trained using training data 106 prior to a deployment with the system 100 (e.g., at a ground-based facility).

In some implementations, the machine-learned model can be re-trained (e.g., using expert labeled data). For example, a set of waveform pulses can be collected by the wind sensor package 124 at a particular altitude and provided to the machine-learned model 116. The machine-learned model 116 can determine a temperature and a pressure at the particular altitude. A separate verification of the temperature and pressure at the particular altitude, e.g., using conventional methods, can be collected and compared to the results of the machine-learned model. Feedback can be generated responsive to the comparison between the atmospheric conditions data determined by the machine-learned model 116 and the conventional methods. The generated feedback can be provided to the machine-learned model 116 to retrain and refine the model.

Atmospheric Condition Determination

FIG. 6 is a flow diagram of an example process 600 for determining atmospheric conditions using the atmospheric conditions measurement system 100.

Data is received relating to ambient temperature and pressure conditions collected at a particular altitude (602). Altitudes can be greater than 10 km above sea level, and more specifically range between 16-22 km. Air temperatures for these altitudes may range between −60° C. and elevated temperatures at sea level (e.g., 40° C.). Atmospheric pressures for these altitudes may range, for example, between 5-20 kPa.

In some implementations, atmospheric conditions measurement program 114 can provide instructions to the positioning mechanism 120 including a length to set the tether 126 such that the wind sensor package 124 is positioned a distance 122 from the positioning mechanism 120 and the main payload 104. An altitude is determined for the current position of the wind sensor package, based in part on an altitude measurement made by the altimeter 132a and/or altimeter 132b.

A set of measurements is performed by the wind sensor package 124 including a set of waveform pulses collected between pairs of transducers of the sonic anemometer 130a, as described herein with reference to FIG. 2. The atmospheric condition measurement system 100 can collect of set of data (e.g., 2000 data points) for each pair of transducers (e.g., 4 pairs of transducers) along 8 unique vectors of the sonic anemometer 130a. In some implementations, collected data 118 includes a waveform pulse including a number of oscillations (e.g., 20 periods) and a pulse envelope shape.

In some implementations, an onboard computer processing unit (e.g., server 106) can perform a pre-processing step on the collected data 118. A pre-processing step can involve an averaging step to remove the effect of noise on the collected measurements. In one example, the collected data 118 can be truncated, e.g., only a particular time range after pulse transmission is analyzed. In another example, a constant offset, e.g., a DC bias, can be subtracted from the collected measurements.

Collected data 118 is provided to a machine-learned model 116 (604). The collected data that is provided to the machine-learned model 116 includes the set of waveform pulses collected by the wind sensor package 124 and altitude data collected by altimeter 132a and/or altimeter 132b.

Temperature data and/or pressure data is determined by the machine-learned model for the particular altitude (606). The machine-learned model 116 receives, as input, waveform pulses collected by the wind sensor package 124 at the particular altitude and provides, as output, atmospheric conditions data including a determination of atmospheric condition, where the atmospheric conditions are inferred from the waveform pulses. The machine-learned model 116, based on the training data set, associates waveform pulse shapes (e.g., amplitude versus time), time delay, and the like, with a particular set of atmospheric conditions. Atmospheric conditions can include temperature data, pressure data, humidity data, wind speed and direction data, solar radiation data, or another similar variable descriptive of the atmospheric conditions.

Temperature data includes a determination of the temperature of the air surrounding the wind sensor package 124. In some implementations, temperature data includes a determination of a temperature range of the air surrounding the wind sensor package 124. For example, temperature data can be −20°±2° Celsius. Pressure data includes a determination of the atmospheric pressure in the region surrounding the wind sensor package 124. Pressure data can include a determination of a range of pressures for the region surrounding the wind sensor package 124. For example, pressure data can be 5 kPa±0.2 kPa.

In some implementations, a full column of air can be measured through a range of altitudes (e.g., from the upper troposphere through the stratosphere) by changing a position of the balloon 102 and/or changing a position of the wind sensor package 120 using the positioning mechanism 120. For example, a set of altitude measurements can be made by extending/retracting the tether 126 connecting the wind sensor package 124 and the positioning mechanism 120 to control the distance 122 between the wind sensor package 124 and the positioning mechanism 120.

The temperature data and/or pressure data is stored for the particular altitude (608). The collected data 118 can be stored, for example, in a server 106 located on the main payload 104. Collected data 118 can be transmitted through a satellite communication link 112 to the network 110. In some implementations, collected data 118 is transmitted periodically (e.g., once a day, once an hour). Collected data 118 can be transmitted during breaks in traffic between the system 100 and the network 110, for example, when other equipment on the main payload is not actively using the satellite communication link 112 to communicate with the network 110.

In some implementations, the temperature data and/or pressure data is provided to users on user devices 113 over the network 110. For example, data can be provided to users that are interested in the effects of atmospheric conditions on weather prediction, satellite launch conditions, climate change monitoring, or the like. In another example, the atmospheric conditions may be used to predict operating parameters for the balloon 102, for example, to assess balloon health, leak rates, pressure altitudes, etc. Information related to atmospheric conditions at different altitudes can be used by the atmospheric conditions measurement system 100 to control operation of equipment on the main payload 104 of the system 100.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a user computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for determining atmospheric conditions comprising:
receiving data relating to atmospheric conditions collected at a particular altitude, the particular altitude located within the stratosphere;
providing the data to a machine-learned model, the machine-learned model having been trained using a training data set collected in a controlled environment;
determining, by the machine-learned model, atmospheric conditions data for the particular altitude based on the data collected for the particular altitude; and
storing the atmospheric conditions data for the particular altitude.

2. The method of claim 1, wherein the atmospheric conditions comprise an ambient temperature at the particular altitude and the atmospheric conditions data for the particular altitude is temperature data for the particular altitude.

3. The method of claim 2, wherein the atmospheric conditions comprise an absolute pressure at the particular altitude and the atmospheric conditions data for the particular altitude is pressure data for the particular altitude, and
wherein the pressure data and temperature data for the particular altitude are interdependent such that the data collected at the particular altitude depends on both temperature and pressure at the particular altitude.

4. The method of claim 1, wherein the data comprises a set of time-of-flight measurements, each time-of-flight measurement including a sonic pulse between a transmitting transducer and receiving transducer, and wherein each pulse is defined in part by a pulse waveform and a characteristic shape of the pulse waveform.

5. The method of claim 4, wherein the shape of the pulse waveform includes an amplitude of the pulse waveform.

6. The method of claim 4, wherein determining temperature data and pressure data for the particular altitude based on the data collected for the particular altitude is based in part on the characteristic shape of the waveform for each pulse in the set of pulses in the collected data.

7. The method of claim 6, wherein the amplitude of the received pulse waveform is reduced with respect to a transmitted pulse waveform as absolute pressure decreases for a constant atmospheric temperature.

8. The method of claim 4, wherein the data is collected using a sonic anemometer located at the particular altitude, and wherein the set of pulses are ultrasonic pulses.

9. The method of claim 3, wherein the temperature data for the particular altitude is an atmospheric temperature and the pressure data is an absolute pressure at the particular altitude.

10. The method of claim 1, wherein the training data set is generated using a thermal vacuum chamber.

11. The method of claim 1, wherein the particular altitude is located within the upper troposphere.

12. A system for determining atmospheric conditions comprising:
an altitude detection device;
a positioning mechanism;
a wind sensor package, wherein the wind sensor package is positioned at an altitude using the positioning mechanism that is measurable by the altitude detection device; and
one or more computers in data communication with the wind sensor package, positioning mechanism, and altitude detection device, and operable to perform the operations comprising:
receiving data relating to atmospheric conditions collected by the wind sensor package at a particular altitude, the particular altitude located within the stratosphere and determined in part by a position determined by the positioning mechanism of the wind sensor package and altitude data collected by the altitude detection device;
providing the data to a machine-learned model, the machine-learned model having been trained using a training data set collected in a controlled environment;
determining, by the machine-learned model, atmospheric conditions data for the particular altitude based on the data collected for the particular altitude; and
storing the atmospheric conditions data for the particular altitude.

13. The system of claim 12, wherein the atmospheric conditions comprise an ambient temperature at the particular altitude and the atmospheric conditions data for the particular altitude is temperature data for the particular altitude.

14. The system of claim 13, wherein the atmospheric conditions comprise an absolute pressure at the particular altitude and the atmospheric conditions data for the particular altitude is pressure data for the particular altitude, and
wherein the pressure data and temperature data for the particular altitude are interdependent such that the data collected at the particular altitude depends on both temperature and pressure at the particular altitude.

15. The system of claim 12, wherein the particular altitude is located within the upper troposphere.

16. The system of claim 12, wherein the wind sensor package includes a sonic anemometer.

17. The system of claim 12, wherein the positioning mechanism is connected to the wind sensor package by a tether and wherein the positioning mechanism and tether can position the wind sensor package at a particular altitude located in the upper troposphere or stratosphere.

18. The system of claim 12, further comprising a balloon, wherein the one or more computers, the positioning mechanism, and the altitude detection device comprise a main payload for the balloon, and the wind sensor package is attached to the positioning mechanism in the main payload by a tether.

19. The system of claim 18, wherein the wind sensor package is in data communication via a wireless data link to the main payload, and wherein the main payload is in data communication with one or more users via a satellite communication link.
